(19) United States
(12) Patent Application Publication
(10) Pub. No.: US 2023/0136970 A1
(43) Pub. Date: May 4, 2023

(54) Modified naphthalene series water reducing agent for concrete with high slit content, and preparation method and application thereof

(71) Applicant: Beijing College of Finance and Commerce, Beijing (CN)

(72) Inventors: Qiusheng Guo, Beijing (CN); Li Lan, Beijing (CN); Xuemei Zou, Beijing (CN)

(21) Appl. No.: 17/977,092

(22) Filed: Oct. 31, 2022

(30) Foreign Application Priority Data
Nov. 2, 2021 (CN) 202111285915.8

(51) Int. Cl. C04B 24/22

(52) U.S. Cl. CPC C04B 24/22; C04B 2103/302

(57) ABSTRACT

A modified naphthalene series water reducing agent for concrete with high slit content, and preparation method and application thereof, belonging to the field of concrete admixtures, and comprising the following components by weight: 20-30 wt % of naphthalene series water reducing agent, 10-20 wt % of high molecular weight polyethylene, 0.1-1 wt % of solid acid catalyst, and the balance of alkane solvent, and the sum of the components is 100 wt %. The present invention provides a simple preparation method for the water reducing agent, and the prepared solvent can be recycled, moreover, on the premises of not increasing costs, the prepared water reducing agent can not only effectively solve the fluidity decline of fresh concrete prepared by aggregate with high slit content, but improves the mechanical strength and other properties of concrete, in order to meet the construction requirements of concrete works.

### TECHNICAL FIELD

This invention relates to the field of concrete admixtures, particularly relates to modified naphthalene series water reducing agent for concrete with high slit content, and preparation method and application thereof.

### BACKGROUND

Modern concrete is usually composed of cement, coarse and fine aggregates, mineral admixtures, chemical admixtures and water, it is the most widely used building material in the world. Because of its advantages of cheap and easily attainable raw materials, its diversified application, and its ability to meet all sorts of engineering properties, modern concrete is widely used in various engineering works.

Due to the rapid development of large-scale infrastructure construction and the stringent environmental protection policy, coarse and fine aggregate resources, including natural sand and gravel, have become increasingly scarce, the aggregate with quality, good particle size distribution and low silt content tend to decrease, especially in civil construction, a large number of manufactured sand with high silt content and high stone powder content are directly used in concrete mixing. The higher slit content causes more consumption of water reducing agent, resulting in lowering both water reducing rate and slump retention of concrete.

At present, many researchers have done a lot of research on the silt content of aggregates, and some related patents have also been published. China patent CN102358763A discloses a preparation method of an additive for inhibiting the side effects of slit, according to the patent, unsaturated monocarboxylic acids and its monomer derivative, chain transfer to monomer and comonomers are copolymerized in an aqueous solution under the action of an initiator, then neutralized with an alkaline solution. However, the polycarboxylate superplasticizer prepared by this invention is costly, and the water reducing rate and slump retention still need to be improved. Another example is China patent CN104891853B, disclosing a combination of anti mud agent and anti sludge pumping agent based on polycarboxylate pumping agent and preparation method therefore, wherein, the product by this invention is made by mixing water with water-reducing component, retarding component, air-entraining component and anti-mud component. Although it can reduce the influence of sand and gravel content on fluidity and slump loss over time, the preparation method of this product has many complicated steps, which invisibly increases the cost and is not conducive to industrial production.

Another example is patent 104017125B, disclosing a clay-resistant polycarboxylic acid water reducer that can be compounded with naphthalene water reducer and a preparation method thereof, according to this patent, the prepared polycarboxylate superplasticizer is compounded with naphthalene superplasticizer, which can solve the incompatibility between polycarboxylate superplasticizer and naphthalene superplasticizer. Moreover, it has anti-mud effect, and can improve the fluidity of concrete prepared with high silt content aggregate. However, one of the purposes of this compounding is based on the insensitivity of naphthalene superplasticizer to clay, and its low cost.

### SUMMARY

The purpose of this invention is to provide a modified naphthalene series water reducing agent for concrete with high slit content, and preparation method and application thereof, on the one hand, it solves the sensitivity problem of polycarboxylate superplasticizer to aggregates with high silt content, on the other hand, it fully exploits the advantages of traditional naphthalene superplasticizer in low cost and stable performance, moreover, this invention uses high molecular weight polyethylene side chain to effectively block the adsorption of layered clay to modified naphthalene water reducer, which can solve fluidity decline of fresh concrete prepared with high silt content aggregate, and effectively improve the mechanical strength and other properties of concrete, in order to meet the construction requirements of concrete works.

To achieve the purpose described above, this invention provides the following technical solutions:

A modified naphthalene series water reducing agent for concrete with high slit content, comprising the following components by weight: 20-30 wt % of naphthalene series water reducing agent, 10-20 wt % of high molecular weight polyethylene, 0.1-1 wt % of solid acid catalyst, and the balance of alkane solvent, and the sum of the components is 100 wt %.

Preferably, the structural formula of naphthalene series water reducing agent is illustrated as follows:

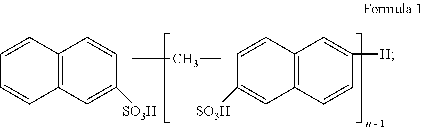

wherein, n is 10-14.

Preferably, the naphthalene series water reducing agent is an intermediate prepared through sulfonation, hydrolysis and condensation, and its main component is industrial naphthalene, and the relative molecular weight of naphthalene series water reducing agent is 2000 g/mol-3000 g/mol.

Preferably, the structural formula of high molecular weight polyethylene is illustrated as follows:

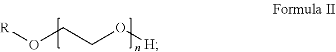

wherein, R is a saturated or unsaturated alkyl (C12-C18), and n is 100-150.

Preferably, the high molecular weight polyethylene is a nonionic surfactant with a relative molecular weight of more than 5000 g/mol.

Preferably, the solid acid catalyst, including one or more of copper sulfate, zinc sulfate and manganese sulfate.

Preferably, the alkane solvent, including one or more of Heptane, Octane, Undecane or Dodecane.

This invention also provides a preparation method of modified naphthalene series water reducing agent for concrete with high slit content, comprising the following steps:

Step 1, mixing alkane solvent, naphthalene water reducing agent, high molecular weight polyethylene and solid acid catalyst for esterification, in order to obtain esters;

Step 2, mixing esters with a water carrying agent for reaction, in order to obtain the modified naphthalene-based water reducing agent for high-silt-content concrete.

Preferably, the temperature of esterification is 120° C.-160° C. and the reaction time is 3-4 h.

This invention further provides a modified naphthalene series water reducing agent for concrete with high slit content, and the application of the modified naphthalene series water reducing agent in fresh concrete prepared by aggregate with high slit content.

This invention provides a modified naphthalene series water reducing agent for concrete with high slit content, comprising the following components by weight: 20-30 wt % of naphthalene series water reducing agent, 10-20 wt % of high molecular weight polyethylene, 0.1-1 wt % of solid acid catalyst, and the balance of alkane solvent, and the sum of the components is 100 wt %.

According to the invention, the modified naphthalene series water reducing agent for concrete with high slit content contains naphthalene sulfonate component, which enables cement particles for electrostatic adsorption, hence adsorbing a large amount of anionic charges to the surface of cement particles, and then the cement particles are uniformly dispersed by electrostatic repulsion among cement particles. According to this invention, the molecular structure of the modified naphthalene series water reducing agent has high molecular weight polyoxyethylene side chains introduced through esterification, and its spatial steric impedance size is much larger than the layer spacing of clay, which effectively hinders the adsorption of clay to the modified naphthalene series water reducing agent, therefore, this invention solves serious loss of fluidity of concrete prepared with high silt aggregate, moreover, according to this invention, naphthalene series water reducing agent and polyoxyethylene are bonded by chemical bonds, making the structure stable and not affected by system temperature and pH. Overall, the invention has the advantages of simple production equipment, concise operation steps, available raw materials, low production cost and convenience for industrial production.

### DETAILED DESCRIPTION OF EMBODIMENTS

A modified naphthalene series water reducing agent for concrete with high slit content, comprising the following components by weight: 20-30 wt % of naphthalene series water reducing agent, 10-20 wt % of high molecular weight polyethylene, 0.1-1 wt % of solid acid catalyst, and the balance of alkane solvent, and the sum of the components is 100 wt %.

According to this invention, the naphthalene series water reducing agent is 20-30 wt %%, preferably 22-28 wt %, more preferably 25 wt %;

Preferably, the structural formula of naphthalene series water reducing agent is illustrated as follows:

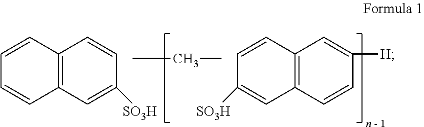

wherein, n is 10-14.

Preferably, the naphthalene series water reducing agent is an intermediate prepared through sulfonation, hydrolysis and condensation, and its main component is industrial naphthalene, and the relative molecular weight of naphthalene series water reducing agent is 2000 g/mol-3000 g/mol.

According to the invention, the source of the naphthalene series water reducing agent is not particularly limited, and the naphthalene series water reducing agent can be synthesized by a conventional synthesis method or purchased from market directly. Furthermore, the modified naphthalene series water reducing agent for concrete with high slit content contains naphthalene sulfonate component, which can make cement particles have electrostatic adsorption, hence adsorbing a large amount of anionic charges to the surface of cement particles, and then the cement particles are uniformly dispersed by electrostatic repulsion among cement particles.

According to this invention, the high molecular weight polyoxyethylene is 10-20 wt %, preferably 12-18 wt %, more preferably 15 wt %.

the structural formula of high molecular weight polyethylene is illustrated as follows:

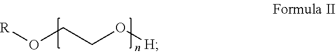

wherein, R is a saturated or unsaturated alkyl (C12-C18), and n is 100-150.

The high molecular weight polyoxyethylene is a nonionic surfactant, and its relative molecular weight is preferably greater than 5000 g/mol.

According to the invention, the source of the high molecular weight polyoxyethylene is not particularly limited, and it can be synthesized by a conventional synthesis method or purchased from market directly. Furthermore, the molecular structure of the modified naphthalene series water reducing agent has high molecular weight polyoxyethylene side chains introduced through esterification, and its spatial steric impedance size is much larger than the layer spacing of clay, which effectively hinders the adsorption of clay to the modified naphthalene series water reducing agent, therefore, this invention solves serious loss of fluidity of concrete prepared with high silt aggregate, moreover, according to this invention, naphthalene series water reducing agent and polyoxyethylene are bonded by chemical bonds, making the structure stable and not affected by system temperature and pH.

According to this invention, the solid acid catalyst is 0.1-1 wt %, preferably 0.3-0.8 wt %, more preferably 0.5 wt %; the solid acid catalyst preferably comprises one or more of copper sulfate, zinc sulfate and manganese sulfate. The source of the solid acid catalyst is not particularly limited, and commercial products well known in the art can be used.

According to this invention, under the action of solid acid catalyst, the sulfonic acid group on the molecular structure of nnaphthalene series water reducing agent and the terminal hydroxyl group on the molecular structure of polyoxyethylene are made for esterification, and subsequent modified naphthalene series water reducing agent contains naphthalene sulfonate components, which enable cement particles for electrostatic adsorption, hence adsorbing a large amount of anionic charges to the surface of cement particles, and then the cement particles are uniformly dispersed by electrostatic repulsion among cement particles.

According to this invention, the alkane solvent preferably includes one or more of heptane, octane, undecane or dodecane. According to the invention, the source of the alkane solvent is not particularly limited, and available products well known in the art can be used. Furthermore, the alkane solvent is the reaction solvent of esterification, and it is used for dissolving naphthalene water reducer, high molecular weight polyoxyethylene and solid acid catalyst.

This invention also provides a preparation method of modified naphthalene series water reducing agent for concrete with high slit content, comprising the following steps:

Step 1, mixing alkane solvent, naphthalene water reducing agent, high molecular weight polyethylene and solid acid catalyst for esterification, in order to obtain esters;

Step 2, mixing esters with a water carrying agent for reaction, in order to obtain the modified naphthalene-based water reducing agent for high-silt-content concrete.

According to the invention, alkane solvent, naphthalene series water reducing agent, high molecular weight polyoxyethylene and solid acid catalyst are mixed for esterification to obtain esterification reaction products.

According to the invention, it is preferable to add alkane solvent into a three-necked flask, and then add naphthalene series water reducing agent, high molecular weight polyoxyethylene and solid acid catalyst.

According to the invention, the temperature of the esterification is preferably 120° C.-160° C., more preferably 130° C.-150° C., most preferably 140° C., and the time of the esterification is preferably 3-4 h, more preferably 3.5 h.

According to the invention, It mixes the obtained esters with a water-carrying agent for reaction, thus obtaining the modified naphthalene series water reducing agent for concrete with high slit content.

Preferably, a water-carrying agent is preferably added into the esters, and the reaction continues for 1-2 h before completion.

According to this invention, the water-carrying agent is preferably isopropanol, the dosage of the water-carrying agent is preferably 1-2 wt %, and the mass ratio of the water-carrying agent to the high molecular weight polyoxyethylene is preferably 1:10. Furthermore, the source of isopropanol is not particularly limited, and commercially available products well known in the art can be used.

After the reaction is completed, the present invention preferably recovers alkane solvent through reduced pressure distillation, in order to obtain the modified naphthalene series water reducing agent for concrete with high slit content.

According to the invention, the pressure of the vacuum distillation is preferably not less than −0.09 MPa, the temperature is preferably 30° C.˜50° C., and the time is preferably 2-4 h.

The present invention further provides the modified naphthalene series water reducing agent for concrete with high slit content and the application of modified naphthalene series water reducing agent for concrete with high slit content prepared by the preparation method in preparing concrete with high silt content aggregate.

The following embodiments explain in detail the modified naphthalene series water reducing agent for concrete with high slit content, its preparation method and application, but they should not be understood as limiting the protection scope of the present invention.

### Embodiment 1

A modified naphthalene series water reducing agent for concrete with high slit content, comprising the following components by weight:

20 wt % of naphthalene series water reducing agent, 10 wt % of high molecular weight polyethylene, 0.1 wt % of solid acid catalyst (copper sulfate), and 69.9 wt % alkane solvent (heptane);

69.9 wt % alkane solvent was added into a three-necked flask, next, 20 wt % naphthalene water reducer, 10 wt % high molecular weight polyethylene and 0.1 wt % solid acid catalyst were added, and the temperature was raised to 120° C.;

esterification was carried out at 120° C. for 3 h, then isopropanol water-carrying agent was added into the reaction, and the reaction was carried on for 1 h;

vacuum distillation was applied after the reaction is finished, the alkane solvent was recovered, and modified naphthalene series water reducing agent for concrete with high slit content was obtained.

### Embodiment 2

A modified naphthalene series water reducing agent for concrete with high slit content, comprising the following components by weight:

20 wt % naphthalene series water reducing agent, 10 wt % high molecular weight polyethylene, 0.1 wt % solid acid catalyst (zinc sulfate) and 69.9 wt % alkane solvent (octane);

69.9 wt % alkane solvent was added into a three-necked flask, next, 20 wt % naphthalene series water reducing agent, 10 wt % high molecular weight polyoxyethylene and 0.1 wt % solid acid catalyst were added, and the temperature was raised to 140° C.;

esterification at 140° C. for 3.5 h, during which, isopropanol water-carrying agent was added, and the reaction was carried on for 1.5 h;

vacuum distillation was carried out after the reaction was finished, the alkane solvent was recovered, and the modified naphthalene series water reducing agent for concrete with high slit content was obtained.

### Embodiment 3

A modified naphthalene series water reducing agent for concrete with high slit content, comprising the following components by weight:

20 wt % naphthalene series water reducing agent, 10 wt % high molecular weight polyoxyethylene, 0.1 wt % solid acid catalyst (manganese sulfate) and 69.9 wt % alkane solvent (undecane);

69.9 wt % alkane solvent was added into a three-necked flask, then 20 wt % naphthalene water reducer, 10 wt % high molecular weight polyoxyethylene and 0.1 wt % solid acid catalyst were added, and the temperature was raised to 160° C.;

Esterification was carried out at 160° C. for 4 h, during which, isopropanol water-carrying agent was added, and the reaction was carried on for 2 h;

vacuum distillation was carried out after the reaction is finished, the alkane solvent was recovered, and the modified naphthalene series water reducing agent for concrete with high slit content was obtained.

### Embodiment 4

A modified naphthalene series water reducing agent for concrete with high slit content, comprising the following components by weight:

25 wt % naphthalene series water reducing agent, 15 wt % high molecular weight polyoxyethylene, 0.5 wt % solid acid catalyst (zinc sulfate) and 59.5 wt % alkane solvent (dodecane), and the sum of all components was 100 wt %.

59.5 wt % alkane solvent was added into a three-necked flask, then 25 wt %% naphthalene series water reducing agent, 15 wt % high molecular weight polyoxyethylene and 0.5 wt % solid acid catalyst were added, and the temperature was raised to 120° C.;

esterification was carried out at 120° C. for 4 h, during which, isopropanol water-carrying agent was added, and the reaction was carried on for 2 h;

vacuum distillation was carried out after the reaction is finished, the alkane solvent was recovered, and the modified naphthalene series water reducing agent for concrete with high slit content was obtained.

### Embodiment 5

A modified naphthalene series water reducing agent for concrete with high slit content, comprising the following components by weight:

30 wt % naphthalene series water reducing agent, 20 wt % high molecular weight polyoxyethylene, 1 wt % solid acid catalyst (manganese sulfate) and 49 wt % alkane solvent (heptane), and the sum of all components was 100 wt %.

49 wt % alkane solvent was added into a three-necked flask, then 30 wt % naphthalene water reducer, 20 wt % high molecular weight polyoxyethylene and lwt % solid acid catalyst were added, and raising the temperature to 150° C.;

Esterification was carried out at 150° C. for 3 h, during which, isopropanol water-carrying agent was added, and reaction was carried on for 2 h;

vacuum distillation was carried out after the reaction is finished, the alkane solvent was recovered, and the modified naphthalene series water reducing agent for concrete with high slit content was obtained.

### Embodiment 6

A modified naphthalene series water reducing agent for concrete with high slit content, comprising the following components by weight:

30 wt % naphthalene series water reducing agent, 20 wt % high molecular weight polyoxyethylene, 0.5 wt % solid acid catalyst (manganese sulfate) and 49.5 wt % alkane solvent (octane), and the sum of all components was 100 wt %.

49.5 wt % alkane solvent was added into a three-necked flask, then 30 wt % naphthalene series water reducing agent, 20 wt % high molecular weight polyoxyethylene and 0.5 wt % solid acid catalyst were added, and the temperature was raised to 130° C.;

esterification at 130° C. for 4 h, during which isopropanol water-carrying agent was added, and reaction was carried on for 2 h;

vacuum distillation was carried out after the reaction is finished, the alkane solvent was recovered, and the modified naphthalene series water reducing agent for concrete with high slit content was obtained

### Embodiment 7

A modified naphthalene series water reducing agent for concrete with high slit content, comprising the following components by weight:

25 wt % naphthalene series water reducing agent, 15 wt % high molecular weight polyoxyethylene, 0.2 wt % solid acid catalyst (copper sulfate) and 59.8 wt % saturated alkane solvent (octane), and the sum of all components was 100 wt %.

59.8 wt % alkane solvent was added into a three-necked flask, then 25 wt % naphthalene series water reducing agent, 15 wt % high molecular weight polyoxyethylene and 0.2 wt % solid acid catalyst were added, and the temperature was raised to 140° C.;

esterification at 140° C. for 3.5 h, during which isopropanol water-carrying agent was added, and reaction was carried on for 2 h;

vacuum distillation was carried out after the reaction is finished, the alkane solvent was recovered, and the modified naphthalene series water reducing agent for concrete with high slit content was obtained

### Embodiment 8

A modified naphthalene series water reducing agent for concrete with high slit content, comprising the following components by weight:

25 wt % naphthalene series water reducing agent, 15 wt % high molecular weight polyoxyethylene, 1 wt % solid acid catalyst (copper sulfate) and 59 wt % alkane solvent (heptane), and the sum of all components was 100 wt %.

51 wt % alkane solvent was added into a three-necked flask, then 25 wt % naphthalene series water reducing agent, 15 wt % high molecular weight polyoxyethylene and 1 wt % solid acid catalyst were added, and the temperature was raised to 160° C.;

esterification at 160° C. for 2 h, during which isopropanol water-carrying agent was added, and reaction was carried on for 2 h;

vacuum distillation was carried out after the reaction is finished, the alkane solvent was recovered, and the modified naphthalene series water reducing agent for concrete with high slit content was obtained

### Comparative Embodiment 1

100 wt % naphthalene series water reducing agent procured from the market.

### Comparative Embodiment 2

40% solid polycarboxylate water reducing agent procured from the market

Net fluidity of cement paste test:

the fluidity of cement paste refers to the national standard GB/T 8077-2012 “Test Method for Uniformity of Concrete Admixtures”.

According to the clay mixing method to replace the corresponding quality of cement, the mixing amount is 5%; cement is the benchmark cement; comparative embodiment 1 uses commercially available naphthalene series water reducing agent (FDN) with the admixture content of 0.75% (based on the weight of cement after consolidation), and comparative embodiment 2 uses commercially available polycarboxylate water reducing agent with the admixture content of 0.20% (based on the weight of cement after consolidation), and the water-cement ratio of cement paste is 0.29.

See Table 1 for the test results.

Test results of fluidity and concrete performance of cement paste that uses modified naphthalene series water reducing agent provided by this invention

TABLE 1

| | | | | Compressive | |
|---|---|---|---|---|---|
| | Fluidity of | | | strength/MPa | |
| | cement | | Concrete | 7 d | 28 d |
| | paste/mm | | slump | Compressive | Compressive |
| Sample | Initial | 1 h | loss | strength/MPa | strength/MPa |
| Embodiment 1 | 282 | 274 | 205 | 24.8 | 25.5 |
| Embodiment 2 | 290 | 276 | 210 | 25.6 | 26.8 |
| Embodiment 3 | 286 | 269 | 205 | 24.2 | 24.6 |
| Embodiment 4 | 285 | 272 | 208 | 24.9 | 25.7 |
| Embodiment 5 | 294 | 280 | 225 | 25.8 | 26.7 |
| Embodiment 6 | 294 | 278 | 223 | 26.5 | 38.2 |
| Embodiment 7 | 293 | 280 | 223 | 26.9 | 38.4 |
| Embodiment 8 | 289 | 278 | 210 | 23.8 | 25.9 |
| Comparative | 276 | 252 | 203 | 21.6 | 31.9 |
| embodiment 1 | | | | | |
| Comparative | 255 | 210 | 168 | 19.2 | 28.7 |
| embodiment 2 | | | | | |

As can be seen from Table 1, the products of Embodiment 1-8 prepared by the present invention all have excellent initial net fluidity of cement paste and 1 h elapsed net of cement paste; However, the initial fluidity of the cement paste of the commercial unmodified naphthalene series water reducing agent in Comparative Embodiment 1 became worse, and the 1 h elapsed loss was 8.7%, the compatibility between the commercial polycarboxylate water reducing agent and clay was obvious, the initial fluidity of the cement paste is only 255 mm, and the 1 h elapsed loss fluidity loss rate was as high as 17.6%. Compared with the comparative embodiment, the concrete slump loss and 7-day and 28-day compressive strength were also greatly improved.

The above are only the preferred embodiments of the present invention, and it should be pointed out that for those of ordinary skill in the technical field, without departing from the principle of the present invention, several improvements and embellishments can be made, and these improvements and embellishments should also be regarded as the protection scope of the present invention.

1. A modified naphthalene series water reducing agent for concrete with high slit content, comprising the following components by weight: 20-30 wt % of naphthalene series water reducing agent, 10-20 wt % of high molecular weight polyethylene, 0.1-1 wt % of solid acid catalyst, and the balance of alkane solvent, and the sum of the components is 100 wt %;
wherein the naphthalene series water reducing agent is an intermediate prepared through sulfonation, hydrolysis and condensation, and its main component is industrial naphthalene, and the relative molecular weight of naphthalene series water reducing agent is 2000 g/mol-3000 g/mol;
wherein the preparation method of modified naphthalene series water reducing agent for concrete with high slit content comprising the following steps:
mixing alkane solvent, naphthalene water reducing agent, high molecular weight polyethylene and solid acid catalyst for esterification, in order to obtain esters;
mixing esters with a water carrying agent for reaction, in order to obtain the modified naphthalene-based water reducing agent for high-silt-content concrete; and
wherein the temperature of esterification is 120° C.-160° C. and the reaction time is 3˜4 h.

2. The modified naphthalene series water reducing agent for concrete with high slit content, according to claim 1, wherein, the structural formula of naphthalene series water reducing agent is illustrated as follows: 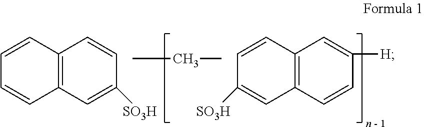
wherein, n is 10-14.

3. (canceled)

4. The modified naphthalene series water reducing agent for concrete with high slit content, according to claim 1, wherein, the structural formula of high molecular weight polyethylene is illustrated as follows: 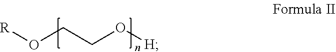
wherein, R is a saturated or unsaturated alkyl (C12-C18), and n is 100-150.

5. The modified naphthalene series water reducing agent for concrete with high slit content, according to claim 1, wherein, the high molecular weight polyethylene is a nonionic surfactant with a relative molecular weight of more than 5000 g/mol.

6. The modified naphthalene series water reducing agent for concrete with high slit content, according to claim 1, wherein, the solid acid catalyst, including one or more of copper sulfate, zinc sulfate and manganese sulfate.

7. The modified naphthalene series water reducing agent for concrete with high slit content, according to claim 1, wherein, the alkane solvent, including one or more of heptane, octane, undecane or dodecane.

8. (canceled)

9. (canceled)

10. An application method of the modified naphthalene series water reducing agent for concrete with high slit content, according to claim 1 in fresh concrete prepared by aggregate with high slit content.
